(19) United States
(12) Patent Application Publication
(10) Pub. No.: US 2026/0229501 A1
(43) Pub. Date: Aug. 6, 2026

(54) ANODE MATERIAL AND BATTERY

(71) Applicants: BTR NEW MATERIAL GROUP CO., LTD., Shenzhen (CN); DINGYUAN NEW ENERGY TECHNOLOGY CO., LTD., Huizhou (CN)

(72) Inventors: Yiming KONG, Shenzhen (CN); Chunlei PANG, Shenzhen (CN); Songtao GUO, Shenzhen (CN); Jianguo REN, Shenzhen (CN); Xueqin HE, Shenzhen (CN)

(73) Assignees: BTR NEW MATERIAL GROUP CO., LTD., Shenzhen (CN); DINGYUAN NEW ENERGY TECHNOLOGY CO., LTD., Huizhou (CN)

(21) Appl. No.: 19/638,338

(22) Filed: Apr. 3, 2026

Related U.S. Application Data
(63) Continuation of application No. PCT/CN2024/119783, filed on Sep. 19, 2024.

(30) Foreign Application Priority Data
Oct. 31, 2023 (CN) 202311441600.7

(51) Int. Cl. H01M 4/36; H01M 4/48; H01M 4/587; H01M 10/0525

(52) U.S. Cl. CPC H01M 4/366; H01M 4/48; H01M 4/587; H01M 10/0525

(57) ABSTRACT

Provided is anode material and battery. The anode material includes silicon, and at least a portion of the silicon is present in the form of crystalline silicon. Based on a mass content of the silicon in the anode material being 100%, a mass content of the crystalline silicon is A %, and an average silicon grain size of the crystalline silicon is B nm. The anode material satisfies the following features: 0.3≤A/B≤60 and 6≤A+B≤75. According to the anode material and the battery provided in the present disclosure, the anode material can achieve an ideal balance among cycling performance, capacity utilization, and rate performance.

### CROSS-REFERENCE TO RELATED APPLICATIONS

The present application is a continuation of International Patent Application No: PCT/CN2024/119783 filed on Sep. 19, 2024, which claims priority to Chinese Patent Application No. 202311441600.7 filed on Oct. 31, 2023, the disclosure of each of which are hereby incorporated by reference for all purposes.

### BACKGROUND

### Field

The present disclosure relates to the field of anode materials, and in particular, to anode material and battery.

### Description of Related Art

Electrified new energy vehicles represent the future development direction of the automotive market, with lithium-ion batteries being their core component. With the development of the market, the need for batteries with high-capacity density is increasing. The use of novel cathode and anode materials with high specific capacity is an important approach to increasing the energy density of batteries.

More and more new materials, such as metals, oxides, and metal alloys, are being used as active materials in the anode materials to continuously explore improvements in battery energy density of batteries. Among these active materials, silicon-based anode materials are widely recognized as the next-generation anode materials because they exhibit an ultrahigh theoretical specific capacity (4200 mAh/g) and a relatively low lithium deintercalation potential (<0.5 V). Moreover, a voltage plateau of silicon is slightly higher than that of graphite, which reduces the risk of lithium plating on the surface during charging after battery assembly, thereby providing improved safety performance. However, the silicon-based anode materials undergo severe volume expansion during cycling, resulting in pulverization and fragmentation of the anode materials, leading to rapid cycling performance degradation of the battery.

In order to solve this problem, conventional approaches adopted in the industry include coating the silicon-based anode material, secondary granulation, and controlling the silicon grain size. However, in existing technical solutions, during the heat treatment process of the silicon-based anode materials, the silicon grain size tends to increase rapidly, and elemental Si leads to greater volume expansion. Therefore, how to control the average silicon grain size to reduce volume expansion and improve the cycling stability of the anode material remains an urgent problem to be solved.

### SUMMARY

The present disclosure provides anode material and battery. By controlling a relationship between a mass ratio of crystalline silicon and an average silicon grain size in a silicon-containing material, the volume expansion of the anode material may be reduced, and the cycling stability of the anode material may be improved.

In first aspect, the present disclosure provides an anode material. The anode material contains silicon, and at least a portion of the silicon is present in the form of crystalline silicon.

Based on a mass content of silicon in the anode material being 100%, a mass content of the crystalline silicon is A %, and an average silicon grain size of the crystalline silicon is B nm.

The anode material satisfies the following features: 0.3≤A/B≤60 and 6≤A+B≤75.

In second aspect, the present disclosure provides a battery, including the anode material in the first aspect.

The technical solutions of the present disclosure have at least the following beneficial effects.

The anode material provided in the present disclosure, by controlling the relationship between the mass ratio of crystalline silicon in silicon and the average silicon grain size, can reduce lithium-ion transport impedance during charging and discharging, improve the stability of a solid-liquid interface between the anode material and an electrolyte, and significantly enhance the stability of the crystalline structure during long-term cycling. Specifically, crystalline silicon is structurally more stable than amorphous silicon. In a battery electrode plate fabricated from such material, the peak intensity and peak position of crystalline silicon in a dQ/dV curve undergo little change during cycling. However, the expansion of crystalline silicon is anisotropic, resulting in non-uniform expansion stress that can lead to fragmentation of anode particles and exposure of more silicon interfaces to the electrolyte. This, in turn, induces side reactions with the electrolyte and continuous growth and thickening of a Solid Electrolyte Interphase (SEI) film, leading to degradation of interface stability. Amorphous silicon (including elemental and compound forms) may stabilize the overall structure of the anode particles and buffer expansion deformation, thereby reducing fragmentation of the particles and improving interface stability. At the same time, the amorphous material is isotropic, such that lithium intercalation does not exhibit directional preference, resulting in lower lithium-ion transport impedance. The silicon grain size also affects the stability of the anode material. By regulating both the mass ratio of crystalline silicon and the average silicon grain size in the anode material, the effects of two parameters, namely the silicon grain size and the mass ratio between crystalline silicon and amorphous silicon, on electrochemical performance may be balanced. This enables the anode material to achieve low lithium-ion transport impedance, high stability of the solid-liquid interface, and strong stability of the crystalline structure during long-term cycling, thereby significantly enhancing product performance.

### BRIEF DESCRIPTION OF THE DRAWINGS

FIG. 1 is a schematic flowchart of a method for preparing an anode material according to an embodiment of the present disclosure.

FIG. 2 is a schematic diagram illustrating a battery in a discharging state.

FIG. 3 is a comparison diagram of cycling performance of anode materials provided in Embodiment 1 and Comparative example 1 of the present disclosure.

### DETAILED DESCRIPTION OF THE EMBODIMENTS

The following are preferred implementations of embodiments of the present disclosure. It is to be noted that those of ordinary skill in the art may also make several improvements and refinements without departing from the principle of the embodiments of the present disclosure, and these improvements and refinements shall all fall within the scope of protection of the embodiments of the present disclosure.

Specifically, the present disclosure provides an anode material. The anode material contains silicon, and at least a portion of the silicon is present in the form of crystalline silicon.

Through X-Ray Diffraction (XRD) analysis, based on a mass content of silicon in the anode material being 100%, a mass content of the crystalline silicon is A %, and an average silicon grain size is B nm, satisfying 0.3≤A/B≤60 and 6≤A+B≤75.

In the above solution, by controlling a relationship between the mass ratio of crystalline silicon and the average silicon grain size in silicon, lithium-ion transport impedance during charging and discharging can be reduced, the stability of a solid-liquid interface between the anode material and an electrolyte can be improved, and the stability of the crystalline structure during long-term cycling can be significantly enhanced. Specifically, crystalline silicon is structurally more stable than amorphous silicon. In a battery electrode plate fabricated from such material, the peak intensity and peak position of crystalline silicon in a dQ/dV curve undergo little change during cycling. However, the expansion of crystalline silicon is anisotropic, resulting in non-uniform expansion stress that can lead to fragmentation of the anode particles and exposure of more silicon interfaces to the electrolyte. This, in turn, induced side reactions with the electrolyte and continuous growth and thickening of an SEI film, leading to degradation of interface stability. Amorphous silicon (including elemental and compound forms) may stabilize the overall structure of the anode material particles and buffer expansion deformation, thereby reducing fragmentation of the anode material particles and improving interface stability. At the same time, the amorphous material is isotropic, such that lithium intercalation does not exhibit directional preference, resulting in lower lithium-ion transport impedance. The silicon grain size also affects the stability of the anode material. By regulating both the mass ratio of crystalline silicon and the average silicon grain size in the anode material, the effects of two parameters, namely the silicon grain size and the mass ratio between crystalline silicon and amorphous silicon, on the electrochemical performance may be balanced. This enables the anode material to achieve low lithium-ion transport impedance, high stability of the solid-liquid interface, and strong stability of the crystalline structure during long-term cycling, thereby significantly enhancing product performance.

Specifically, a specific value of A/B may, for example, be 0.3, 0.5, 1, 5, 10, 15, 20, 25, 35, 40, 55, 60, or the like. A specific value of A+B may, for example, 6, 8, 10, 15, 20, 25, 35, 40, 45, 50, 55, 60, 65, 70, 75, or the like, which is not limited herein. In the present disclosure, by controlling the values of A/B and A+B, i.e., controlling the relationship between the silicon grain size and the mass ratio of crystalline silicon to amorphous silicon, the volume expansion and long-term cycling stability of the anode material can be balanced.

In some implementations, based on the mass content of silicon in the anode material being 100%, the mass content of the crystalline silicon is A %, and A is in the range of 5-65. A may specifically be in the range of 5, 11, 21, 26, 31, 40, 50, 59, 61, 65, or the like, which is not limited herein. It may be understood that when the mass ratio of the crystalline silicon in the silicon is too low, the amorphous component in silicon becomes excessive, resulting in high reactivity. During charging and discharging, electrochemical sintering is prone to occur under the action of an applied voltage, leading to a rapid increase in the average silicon grain size. Under the combined effects of severe structural changes and uncontrollably large silicon grains, the cycling performance of the product deteriorates. Conversely, when the mass ratio of the crystalline silicon in the silicon is too high, polarization during charging and discharging increases, resulting in reduced product capacity, as well as decreased rate capability and low-temperature performance of the product. Therefore, controlling the mass ratio of the crystalline silicon within 5%-65% is conducive to suppressing the volume expansion effect of the anode material and improving the cycling performance of the anode material.

In some implementations, the silicon grain size of the crystalline silicon is B nm, and B≤7. Specifically, the average silicon grain size may be 7 nm, 6.5 nm, 6.0 nm, 5.9 nm, 5.5 nm, 5.0 nm, 4.5 nm, 4.0 nm, 3.5 nm, 3 nm, 2.5 nm, 2 nm, 1 nm, or the like, which is not limited herein. It may be understood that when the average silicon grain size is relatively large, the expansion stress of the silicon grains generated during lithium intercalation is non-uniform, which may easily cause fragmentation of the anode material particles, loss of electrochemical activity, and consequently a decrease in the cycling performance of the product. Therefore, controlling the average silicon grain size within the above range is conducive to improving the uniformity of expansion stress in the anode material particles, reducing fragmentation of the particles, and enabling the anode material to achieve an ideal balance state among cycling performance, capacity utilization, and rate capability, thereby achieving optimal overall performance.

In view of the above-mentioned, it may be seen that the mass ratio of the crystalline silicon and the silicon grain size have a mutually compensating effect on the performance of the final anode material. For example, when the silicon grain size is relatively small, i.e., when B is relatively small, it is conducive to the structural stability of the anode particles, thereby alleviating the negative effects on product performance caused by an excessively high mass ratio of the crystalline silicon, i.e., when A is relatively large. Conversely, when the mass ratio of the crystalline silicon is relatively low, i.e., when A is relatively small, more amorphous structures may be provided to buffer the problem of non-uniform stress caused by a large silicon grain size, i.e., when B is relatively large. Therefore, in order to pursue more ideal product performance, in addition to separately limiting the values of the abovementioned A and B, it is more important to establish a relationship between A and B. Studies have shown that when the relationship between A and B satisfies 0.3≤A/B≤60 and 6≤A+B≤75, the mass proportion of crystalline silicon and the silicon grain size achieve an optimal balance, thereby optimizing the performance of the anode material.

In some implementations, the anode material further includes oxygen, and components containing oxygen and silicon in the anode material include, but are not limited to, at least one of a silicon oxide or a silicate. The silicon oxide may be represented by the general formula SiO_{y} (0<y≤2). Specifically, SiO_{y} may be SiO_{0.1}, SiO_{0.2}, SiO_{0.3}, SiO_{0.4}, SiO_{0.5}, SiO_{0.7}, SiO_{0.9}, SiO, SiO_{1.2}, SiO_{1.5}, SiO_{1.8}, SiO_{1.9}, SiO₂, or the like, which is not limited herein. The silicon oxide may be a material formed by dispersing silicon particles in SiO₂, or a material having tetrahedral structural units, with a silicon atom at the center of each tetrahedral unit, and silicon and/or oxygen atoms at four vertices of the tetrahedral unit.

In some implementations, an overall atomic ratio of oxygen to silicon in the anode material is x (0<x<2.2), where x may specifically be 0.1, 0.2, 0.5, 0.8, 0.9, 1, 1.2, 1.5, 1.8, 1.9, 2.1, 2.185, or other values within the above range.

It may be understood that, the components containing silicon in the anode material may include at least one of elemental silicon, a silicon alloy, a silicon oxide, or a silicate. The elemental silicon may be amorphous silicon and/or crystalline silicon, and the silicon alloy may be a silicon-lithium alloy, a silicon-magnesium alloy, a silicon-nickel alloy, or the like.

In some implementations, a mass content of oxygen in the anode material is 10%-55%, which may specifically be 10%, 12%, 15%, 20%, 25%, 30%, 35%, 40%, 45%, 55%, or the like, or may definitely be other values within the above range, and is not limited herein.

In some implementations, the anode material further includes a doped metal element selected from at least one of Li, Mg, Cu, Ni, Fe, Cr, or Zn. In an elemental distribution spectrum obtained by X-ray scanning of a cross section of the anode material particles using an (Scanning Electron Microscope) SEM, the distribution planes of Si, O, and the doped metal element are uniformly dispersed. In the anode material, Si, O, and the doped metal element are uniformly distributed in the particles, which may effectively prevent air and other components from penetrating the particles and causing deactivation of active components. As a result, the structure and properties do not deteriorate during long-term storage, making the material particularly suitable for use in lithium-ion batteries. The uniformly dispersed state of the metal element is conducive to maintaining a consistent level of expansion and contraction at different locations of the material during lithium intercalation and deintercalation, thereby avoiding stress weak points caused by excessive local expansion. The doped metal may further improve the electrical conductivity of the anode material and enhance the structural strength of the anode material, thereby optimizing material performance. It may be understood that, in the anode material of the present disclosure, at least a portion of the doped metal element is present in the form of a silicate.

In some implementations, the doped metal element contains Mg. A mass content of Mg in the anode material is 3%-25%, which may specifically be 3%, 5%, 8%, 10%, 12%, 14%, 18%, 20%, 23%, 24%, 25%, or other values within the above range.

In some implementations, when the doped metal element contains Mg, the silicon grain size of the crystalline silicon in the anode material is B nm, and B≤15. The average silicon grain size may specifically be 15 nm, 12 nm, 10 nm, 9 nm, 7 nm, 6.0 nm, 5.5 nm, 5.0 nm, 4.5 nm, 4.0 nm, 3 nm, 2 nm, 1 nm, or the like, which is not limited herein. It may be understood that when the metal M is magnesium, the anode material may specifically include MgSiO₃ and Mg₂SiO₄, which may reduce the Si crystallite size and suppress material expansion.

In some implementations, the doped metal element contains Li. A mass content of Li in the anode material is 3%-15%, which may specifically be 3%, 5%, 8%, 9%, 10%, 12%, 13%, 14%, 15%, or other values within the above range.

In some implementations, when the doped metal element contains Li, the silicon grain size of the crystalline silicon in the anode material is B nm, and B≤10. The average silicon grain size may specifically be 10 nm, 9 nm, 7 nm, 6.0 nm, 5.5 nm, 5.0 nm, 4.5 nm, 4.0 nm, 3 nm, 2 nm, 1 nm, or the like, which is not limited herein. It may be understood that at least a portion of the lithium is present in the form of lithium silicate. In this case, the silicon grain size in the anode material is ≤10 nm, which facilitates the dispersed distribution of silicon grains, thereby effectively reducing silicon volume expansion and improving cycling performance.

In some implementations, the anode material further includes carbon, and components containing carbon in the anode material include at least one of amorphous carbon, graphite, graphene, a carbon nanotube, or a carbon fiber. The amorphous carbon may be soft carbon and/or hard carbon, and the graphite may be artificial graphite and/or natural graphite. It may be understood that the components containing carbon may enhance the electrical conductivity of a silicon-based active material. Graphite is a material with high electrical conductivity, low volume expansion, high initial coulombic efficiency, and stable cycling performance.

In some implementations, the anode material includes a carbon layer located on at least a portion of a surface of the anode material. It may be understood that the carbon layer on the surface of the anode material can reduce fragmentation of the material particles caused by repeated formation of an SEI film, thereby improving the cycling performance of the anode material and reducing the volume expansion caused by SEI film formation.

In some implementations, the active material (such as silicon and/or silicon oxide) is dispersed in a carbon-containing material, which formed a conductive network for the active material, thereby overcoming the poor electrical conductivity of the active material (such as silicon and/or silicon oxide) and facilitating the capacity utilization and cycling stability of silicon oxide. In some implementations, a mass content of carbon in the anode material is 1%-40%, which may specifically be 2%, 5%, 8%, 10%, 12%, 15%, 18%, 20%, 25%, 28%, 35%, 40%, or the like, or may definitely be other values within the above range, and is not limited herein.

In some implementations, the mass content of silicon in the anode material is 25%-88%, which may specifically be 25%, 30%, 40%, 50%, 55%, 60%, 65%, 70%, 85%, 88%, or the like, or may definitely be other values within the above range, and is not limited herein. Preferably, the mass content of silicon in the anode material is 40%-60%.

In some implementations, in the anode material, the active material and the carbon-containing material are mutually dispersed in the form of particles.

In some implementations, a pH of the anode material is 6-10, which may specifically be 6, 7, 8, 8.5, 9, 9.5, 10, or the like, and is not limited herein. Preferably, a pH value of the anode material is 7-10.

In some implementations, a specific surface area of the anode material is 0.1 m²/g-25 m²/g, which may specifically be 0.1 m²/g, 1.0 m²/g, 1.5 m²/g, 1.8 m²/g, 2.0 m²/g, 2.5 m²/g, 3.0 m²/g, 3.6 m²/g, 4.0 m²/g, 5 m²/g, 5.5 m²/g, 6.0 m²/g, 7.0 m²/g, 8.0 m²/g, 8.5 m²/g, 10.0 m²/g, 12.0 m²/g, 15.0 m²/g, 18.0 m²/g, 25 m²/g, or the like, but is not limited to these listed values, and other unlisted values within this range are also applicable. It may be understood that, a smaller specific surface area is preferable, as an excessively large specific surface area easily lead to SEI film formation, excessive consumption of irreversible lithium, and reduced initial coulombic efficiency of the battery. Considering the cost of the preparation process, the specific surface area of the anode material is preferably 1 m²/g-10 m²/g.

In some implementations, a true density of the anode material is 2.0 g/cm³-3.4 g/cm³, which may specifically be 2.0 g/cm³, 2.2 g/cm³, 2.4 g/cm³, 2.6 g/cm³, 2.8 g/cm³, 2.9 g/cm³, 3.0 g/cm³, 3.2 g/cm³, 3.4 g/cm³, or the like, and other unlisted values within this range are also applicable. Controlling the true density within the above range is beneficial for improving energy density and rate capability of the anode material.

In some implementations, a particle size of the anode material satisfies: D₂₀-D₁₀≤4 μm and D₉₀-D₈₀≤8 μm. D₂₀-D₁₀ may specifically be 1 μm, 1.5 μm, 2 μm, 2.5 μm, 3.5 μm, 4 μm, or the like. D₉₀-D₈₀ may specifically be 1μ, 1.5 μm, 2 μm, 2.5μ, 3.5μ, 5 μm, 5.5 μm, 6μ, 6.5 μm, 8 μm, or the like, which is not limited herein. This indicates that the particle size distribution in both small-particle and large-particle segments of the anode material is sufficiently narrow, with highly uniform particle sizes. By suppressing abnormal particles at both ends of the anode material, side reactions, particle fragmentation, and structural failure are reduced, thereby improving cycling performance, high-temperature storage performance, and electrode processability of the anode.

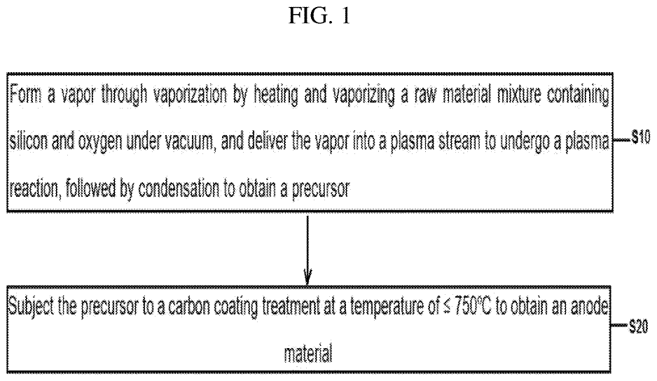

The present disclosure further provides a method for preparing an anode material. As shown in FIG. 1, the method includes the following S10-S20.

At S10, a vapor is formed by heating and vaporizing a raw material mixture containing silicon and oxygen under vacuum, and the vapor is delivered into a plasma stream to undergo a plasma reaction, followed by condensation to obtain a precursor.

At S20, the precursor is subjected to a carbon coating treatment, and a carbon-coated product is subjected to a heat treatment at 800° C.-1100° C. to obtain the anode material. Based on a mass content of silicon in the anode material being 100%, a mass content of the crystalline silicon is A %, and an average silicon grain size is B nm, satisfying 0.3≤A/B≤60 and 6≤A+B≤75.

In the method for preparing the anode material provided by the present disclosure, the vapor formed by heating and vaporizing the raw material mixture is delivered into the plasma stream to undergo the plasma reaction. The plasma has the characteristics of low temperature and high energy level. During condensation and subsequent settling of the precursor vapor in the plasma, silicon microcrystalline seeds are uniformly generated without affecting the overall amorphous state of the material. When such crystal seeds are present in the precursor, they may promote rapid growth of silicon grains in the abovementioned S20, thereby reducing the risk of uncontrolled mass ratio of the crystalline silicon caused by excessively long heat treatment. By combining the plasma condensation process for generating the crystal seeds with high-temperature heat treatment to regulate the crystallization state, 0.3≤A/B≤60 and 6≤A+B≤75 may be achieved. That is, by controlling the relationship between the mass ratio of the crystalline silicon and the average silicon grain size, the anode material can achieve optimal overall performance.

The present solution is specifically introduced below.

At S10, the vapor is formed by heating and vaporizing the raw material mixture containing silicon and oxygen under vacuum, and the vapor is delivered into the plasma stream to undergo the plasma reaction, followed by condensation to obtain the precursor.

In some implementations, the raw material mixture includes at least one of a mixture of Si, SiO_{z}, and SiO₂, a mixture of SiO_{y} and Si, or a mixture of Si and SiO₂, where 0<z<2.

In some implementations, the raw material mixture further includes a doped metal element selected from at least one of Li, Mg, Cu, Ni, Fe, Cr, or Zn. The doped metal element may be added to the raw material mixture in the form of an elemental metal, a metal oxide, or the like.

In some implementations, the doped metal element is selected from Mg and/or Li.

In some implementations, a vacuum pressure is in the range of 1.333×10⁻¹ Pa-1.333×10⁻⁶ Pa, which may specifically be 1.333×10⁻¹ Pa, 1.333×10⁻² Pa, 1.333×10⁻³ Pa, 1.333×10⁻⁴ Pa, 1.333×10⁻⁵ Pa, 1.333×10⁻⁶ Pa, or the like, and is not limited herein.

In some implementations, a heating and vaporization temperature is 1000° C.-1800° C., which may specifically be 1000° C., 1050° C., 1100° C., 1200° C., 1250° C., 1300° C., 1350° C., 1400° C., 1500° C., 1600° C., 1700° C., or 1800° C. It may be understood that the above temperature is not limited to the listed values, and other unlisted values within this range are also applicable.

In some implementations, a gas source for the plasma stream includes at least one of argon, hydrogen, neon, or helium.

In some implementations, radio frequency power of a plasma generating device is 10 kW-100 KW, which may specifically be 10 kW, 20 kW, 30 kW, 40 kW, 50 kW, 60 kW, 70 KW, 80 kW, 90 kW, 100 KW, or the like, which is not limited herein.

In some implementations, the raw material mixture further includes a doped metal element, which includes Li, and a molar ratio of Si to Li in the raw material mixture is (1-50):1, which may specifically be 1:1, 5:1, 10:1, 15:1, 20:1, 25:1, 30:1, 40:1, 50:1, or the like, and is not limited herein.

In some implementations, the raw material mixture further includes a doped metal element, which includes Mg, and a molar ratio of Si to Mg in the raw material mixture is (5-50):1, which may specifically be 5:1, 10:1, 15:1, 20:1, 25:1, 30:1, 40:1, 50:1, or the like, and is not limited herein.

In some implementations, cooling is performed using a protective gas, which includes at least one of nitrogen, argon, neon, krypton, or helium.

In some implementations, the method further includes subjecting the condensed precursor to a pulverization treatment to obtain a precursor having a particle size D₅₀ of 0.1 μm-25 μm. The particle size D₅₀ of the precursor may specifically be 0.1 μm, 0.3 μm, 0.4 μm, 0.5 μm, 1 μm, 2 μm, 3 μm, 4 μm, 6 μm, 10 μm, 12 μm, 15 μm, 20 μm, 25 μm, or the like, which is not limited herein. At S20, the precursor is subjected to the carbon coating treatment, and the carbon-coated product is subjected to the heat treatment at 800° C.-1100° C. to obtain the anode material.

In some implementations, the carbon coating treatment specifically includes at least one of solid-phase carbon coating, liquid-phase carbon coating, or vapor-phase carbon coating. In the present disclosure, the carbon coating treatment is a low-temperature coating (below 800° C.), which can effectively suppress an increase in silicon grain size.

Specifically, the carbon coating treatment include the steps of: heating the precursor obtained by the cooling treatment, introducing a protective gas and a carbon source gas, and pyrolyzing the carbon source gas to obtain a carbon-coated product.

In some implementations, the carbon source gas used in vapor-phase carbon coating includes a hydrocarbon.

In some implementations, the carbon source gas includes at least one of methane, acetylene, ethylene, ethane, propane, propylene, propyne, acetone, or benzene.

In some implementations, a chemical vapor deposition apparatus includes at least one of a rotary chemical vapor deposition reaction furnace, a plasma-enhanced chemical vapor deposition reaction furnace, a chemical vapor deposition tube furnace, or a fluidized bed. Specifically, the chemical vapor deposition apparatus is at least one of a rotary furnace or a box-type furnace.

In some implementations, a pyrolysis temperature is 600° C.-800° C., and a pyrolysis time is 2 h-20 h. The pyrolysis temperature may specifically be 600° C., 620° C., 650° C., 680° C., 700° C., 750° C., 800° C., or the like, which is not limited herein. The pyrolysis time may specifically be 2 h, 3 h, 4 h, 6 h, 8 h, 10 h, 12 h, 15 h, 20 h, or the like, which is not limited herein.

In some implementations, the carbon source gas is introduced under a protective gas.

In some implementations, the protective gas includes at least one of nitrogen, helium, neon, argon, krypton, or xenon.

In some implementations, the carbon coating treatment specifically includes the step of: subjecting a mixture of the precursor obtained by the cooling treatment and a solid-phase carbon source to a carbonization treatment to obtain the anode material.

In some implementations, the solid-phase carbon source includes at least one of sugars, esters, hydrocarbons, organic acids, or polymeric compounds. The solid-phase carbon source may specifically be at least one of polyvinyl chloride, polyvinyl butyral, polyacrylonitrile, polyacrylic acid, polyethylene glycol, polypyrrole, polyaniline, sucrose, glucose, maltose, citric acid, asphalt, furfural resin, epoxy resin, or phenolic resin.

In some implementations, a mixing manner of the cooled product and the carbon source may be VC mixing, fusion, ball milling, three-dimensional mixing, fluidized bed mixing, or the like.

In some implementations, a mass ratio of the solid-phase carbon source to the precursor is 5:(5-95).

In some implementations, a temperature for the carbonization treatment is 500° C.-800° C., and a time for the carbonization treatment is 2 h-20 h. The temperature for the carbonization treatment may specifically be 500° C., 530° C., 580° C., 600° C., 620° C., 650° C., 680° C., 700° C., 750° C., 800° C., or the like, which is not limited herein. The pyrolysis time may specifically be 2 h, 3 h, 4 h, 6 h, 8 h, 10 h, 12 h, 15 h, 20 h, or the like, which is not limited herein.

In some implementations, a device for solid-phase carbon coating is at least one of a rotary furnace, a box-type furnace, a roller kiln, a tunnel kiln, or a pusher kiln.

In some implementations, the protective gas may be at least one of nitrogen, argon, helium, neon, krypton, or xenon.

The liquid-phase carbon coating process specifically includes: uniformly mixing the cooled product with a carbon source, placing the mixture in a furnace, introducing a protective gas, and performing heat treatment to pyrolyze and coat the carbon source onto the surface of the cooled product.

In some implementations, the carbon source for liquid-phase carbon coating is an organic carbon source, which may specifically be low-temperature liquid-phase asphalt, furfuryl alcohol, glycidyl methacrylate, triethylene glycol dimethacrylate, and the like.

In some implementations, the protective gas may be at least one of nitrogen, argon, helium, neon, krypton, or xenon.

In some implementations, when the carbon-coated product is subjected to the heat treatment at 800° C.-1100° C., a holding time for the heat treatment is 0.5 h-18 h, thereby obtaining the anode material.

In some implementations, the temperature for the heat treatment may specifically be 800° C., 850° C., 900° C., 950° C., 1000° C., 1050° C., 1100° C., or the like, which is not limited herein. In some implementations, the holding time for the heat treatment is 0.5 h-18 h, which may specifically be 0.5 h, 1 h, 2 h, 3 h, 4 h, 6 h, 8 h, 10 h, 12 h, 16 h, 18 h, or the like, which is not limited herein. Preferably, the holding time for the heat treatment is 3 h-8 h. The holding time at the maximum temperature during heat treatment is defined as the time during which the temperature measured by a heat treatment device is within +10° C. of the maximum heat treatment temperature. Hereinafter, the term “high-temperature heat treatment time” refers to the same concept and will not be repeated. The embodiments of the present disclosure further provide a lithium-ion battery, which uses the anode material provided in the above embodiments of the present disclosure, or the anode material prepared by the method for preparing the anode material provided in the above embodiments of the present disclosure. The lithium-ion battery provided in the embodiments of the present disclosure has the advantages of excellent rate performance and low expansion.

An implementation of the present disclosure provides a secondary battery (such as a lithium-ion battery, a sodium-ion battery, etc.), including a housing, an electrode assembly, and a liquid electrolyte/solid electrolyte. The electrode assembly and the liquid electrolyte/solid electrolyte are both located in the housing.

The housing may be a packaging bag obtained by packaging with a packaging film (such as an aluminum-plastic film), for example, the secondary battery is a pouch battery. In some other embodiments, the secondary battery may also be a steel-shell battery, an aluminum-shell battery, or the like.

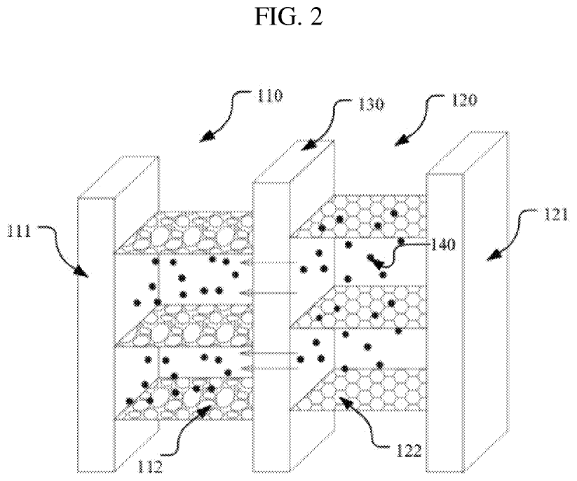

FIG. 2 illustrates a schematic diagram of a battery in a discharging state, i.e., during operation. As shown in the figure, the electrode assembly includes a cathode plate 110, an anode plate 120, and a separator 130. The separator is disposed between the cathode plate and the anode plate. The electrode assembly may be of a laminated structure, which is formed by sequentially alternately stacking the cathode plate, the separator, and the anode plate. In some other embodiments, the electrode assembly may also be of a winding structure, which is formed by first sequentially stacking and then winding the cathode plate, the separator, and the anode plate.

### Cathode Plate

The cathode plate 110 includes a cathode current collector 111 and a cathode active layer 112 disposed on at least one surface of the cathode current collector. The cathode current collector may use aluminum foil, nickel foil, or the like, or may be a composite current collector disclosed in any related art, for example, but not limited to, a current collector that is formed by combining the abovementioned conductive foil and a polymer substrate. The cathode active layer includes a cathode active material, and the cathode active material includes a compound capable of reversibly intercalating and deintercalating metal ions. In some embodiments, the cathode active material may include a lithium transition metal composite oxide, a sodium transition metal composite oxide, and the like. The lithium transition metal composite oxide contains lithium and at least one element selected from cobalt, manganese, and nickel. In some embodiments, the cathode active material may include, but is not limited to, at least one of lithium cobalt oxide (LiCoO₂), a lithium-nickel-manganese-cobalt ternary material (NCM), lithium manganate (LiMn₂O₄), lithium nickel manganese oxide (LiNi_{0.5}Mn_{1.5}O₄), or lithium iron phosphate (LiFePO₄).

### Anode Plate

The anode plate 120 includes an anode current collector 121 and an anode active material layer 122 disposed on at least one surface of the anode current collector. The anode current collector may use at least one of copper foil, nickel foil, stainless steel foil, titanium foil, or a carbon-based current collector, or may be a composite current collector disclosed in any related art, for example, but not limited to, a current collector that is formed by combining the abovementioned conductive foil and a polymer substrate. The anode active material layer includes an anode material.

During operation of the battery, that is, when the battery is in a discharging state, metal ions 140 (such as lithium ions) in the anode deintercalate from a lattice of the anode material, pass through the separator 130 via the liquid electrolyte/solid electrolyte, and intercalate into the lattice of the cathode material.

Conversely, when the battery is charged by applying an external circuit, the oxidation of the cathode material causes metal ions (such as lithium ions) in the cathode to deintercalate from the lattice of the cathode material, pass through the separator via the liquid electrolyte/solid electrolyte, and move to the anode. At the same time, a reduction reaction occurs in the anode material, resulting in the intercalation of the metal ions into the lattice of the anode material.

With the reciprocating movement of the metal ions between the cathode and the anode, the battery may achieve thousands of charge-discharge cycles.

### Test Method

### 1) Particle Size of Anode Material

A particle size testing method was referred to GB/T 19077-2016. A laser particle size analyzer was used for convenient measurement, such as a Mastersizer 3000 laser particle size analyzer from Malvern Instruments Co., Ltd., UK. In the volume-based distribution, the cumulative diameter at 50% was designated as D50, and similarly, D10 and D90 corresponded to the cumulative diameters at 10% and 90%, respectively. During testing, 1 mL of a surfactant aqueous solution diluted to a mass ratio of 1:50 was first taken and added to a beaker containing an appropriate amount (0.3-1 g) of an anode material sample. Then, pure water was added and a mixture is uniformly stirred before testing (a sample-to-water ratio was adjusted to maintain an obscuration rate between 8%-15%).

### 2) Method for Testing Specific Surface Area of Anode Material

A specific surface area of the anode material was measured using a gas adsorption BET method. The specific surface area of a powder sample was measured using a TriStar 3020 surface area and pore size analyzer from Micromeritics, USA. According to GB/T 19587-2017, “Determination of specific surface area of solid materials by gas adsorption using BET method”, a static capacity method was employed. First, a high-temperature dried special BET tube for the specific surface area was taken and weighed as M1. A certain amount of the sample (occupying ½-⅔ of the tube volume) was added, and degassing was performed at 300° C. for one hour. After cooling, the tube was weighed again as M2, and the sample mass was determined as M2-M1. The sample mass was input into a computer, and the test was started. The instrument automatically completed the test, read the data, and recorded the results. It was to be noted that the sample was cooled to room temperature after being purged with nitrogen at 300° C. for 1 h, and the cooling process was still under N₂ purge.

### 3) pH Test of Anode Material

10 g of the anode material was taken, and 10 g of water was added. After stirring for 30 min, the pH value was measured using a pH meter.

### 4) Test of Mass Content of Carbon in Anode Material

The test was referred to reference standard GB/T 38823-2020, titled “Determination of carbon content in anode materials for lithium-ion batteries” and an infrared carbon-sulfur analyzer (Model: G4 ICARUS HF, Bruker, Germany) was used to test the C content in the anode material. The specific test steps were as follows: 0.05-0.1 g of the sample was accurately weighed using a balance with a precision of 0.0001 g and spread evenly in a ceramic crucible. Then, 1.5 g of a multi-component carbon-free flux was added. The crucible was placed under oxygen-rich conditions for high-frequency heating, causing all the carbon in the sample to be oxidized to carbon dioxide gas. After purification, the gas was introduced into a carbon detection cell. The strongest absorption signal of CO₂ at 4.26 μm for infrared radiation was transmitted by a detector as an electrical signal, which was then processed by the computer and the result was output.

### 5) Test for Mass Content of Oxygen in Anode Material

Device information: oxygen-nitrogen-hydrogen elemental analyzer; Model: ONH2000.

The test steps were as follows: 10-11 mg of a sample to be tested was weighed using a balance with a precision of 0.0001 g. The sample was then wrapped with an appropriate amount of pre-treated aluminum foil as a flux and placed in a graphite crucible under a helium gas flow. The crucible was heated to approximately 2300° C. to melt the sample. Oxygen in the sample to be tested was released in the form of carbon monoxide or carbon dioxide, separated from other gaseous products, and introduced into an infrared detector for measurement. During instrument calibration, the standard sample selected had an oxygen content similar to that of the sample to be tested. Each sample was tested in parallel three times, and an average value was taken.

Other settings: degassing time: 45 s, degassing power: 5 kW, flushing time: 20 s, stabilization time: 40 s, infrared integration delay: 2 s, analysis time: 60 s, and analysis power: 4.5 kW.

### 6) Method for Testing Mass Content of Doped Metal Element in Anode Material

The anode material was roasted in an oxygen-containing atmosphere at 750° C. until constant weight was achieved. The material was then dissolved using a mixed acid composed of concentrated HF, concentrated HCl, and concentrated HNO₃ until the solution no longer produced bubbles. The mixed acid was then added again in double the amount, and the solution still produced no bubbles, the solid was separated to obtain a digestion solution of the anode material. The mass content of the doped metal element in the digestion solution was tested using inductively coupled plasma atomic emission spectrometry.

### 7) Method for Testing Average Size of Silicon Grains in Anode Material

The anode material was tested using an XRD analyzer with the model TD3600, manufactured by Dandong Tongda, with the following testing parameters.

| | | | |
|---|---|---|---|
| Divergence slit | 1.0 | Scan range/° | 10-90 |
| D.S./° | | | |
| Anti-scattering slit | 2.0 | Scan step/° | 0.0131303 |
| S.S./° | | | |
| Receiving slit | 9.1 | Scan mode | Continuous |
| S.S./mm | | | |
| Voltage/kV | 40 | Scan speed/(°/s) | 0.292 |
| Current/mA | 40 | Scan time/s | 288 |

The data were processed using X′Pert HighScore Plus software. For the Strip K-Alpha2 project, the parameters were set: K-A1/K-A2 Intensity ratio was 0.5, wavelength ratio corr was 0, and after Strip K-Alpha2 was completed, smoothing was performed with a smooth degree parameter of 1. After an automatic peak search function of the software was applied, the angle range was set to 26-30. Using automatic fitting, data such as the full width at half maximum and the peak position of the Si characteristic peak around 28° were read from the Peak List. These values were substituted into the Scherrer equation to calculate the average silicon grain size. The calculation was performed as follows.

### According to the Scherrer Formula:

$${D}_{h k l} = \frac{K λ}{β cos θ}$$

Where K was a constant related to the crystal shape, generally taken as 0.89; β was the full width at half maximum; θ was the Bragg diffraction angle (in this experiment, 2θ was approximately 28.4°, so θ-14.2°, cos θ-0.97); λ was the wavelength of the incident X-ray (in this experiment, a copper target Kα line was used, λ=0.15406 nm).

### 8) Method for Testing Mass Content of Crystalline Silicon in Anode Material

For each embodiment and comparative example, 4.5 g of the anode material was taken and uniformly mixed with 0.5 g of analytical pure magnesium oxide, sealed and stored. The mixture was then tested using a Dandong Tongda TD3600 X-ray diffractometer according to the established parameters. The obtained XRD data were processed using Jade 6.0 software through steps including background subtraction, smoothing, peak searching, phase identification, and fitting. Each sample was calculated three times, and a Relative Standard Deviation (RSD) was ≤10%, thereby obtaining a mass percentage of crystalline silicon (Mₛᵢ).

The testing parameters were as follows.

| | | | |
|---|---|---|---|
| Divergence slit D.S./° | 1.0 | Scan range/° | 10-90 |
| Anti-scattering slit S.S./° | 1.0 | Scan step/° | 0.02 |
| Receiving slit S.S./mm | 0.4 | Scan mode | Step scanning |
| Voltage/kV | 40 | Integration time per | 2 |
| | | step/s | |
| Current/mA | 40 | Scan time/min | 2:13′20″ |

The carbon content of the anode material in each embodiment and comparative example was tested using the aforementioned testing method, designated as M_{C}. The oxygen content of the anode material in each embodiment and comparative example was tested using the aforementioned method, designated as M_{O}. The total content of metal elements in the anode material in each embodiment and comparative example was tested using the aforementioned method, designated as M_{M}. In summary, the mass ratio of the crystalline silicon is=Mₛᵢ/(1-M_{C}-M_{O}-M_{M}).

### 9) Cycling Performance and Rate Capability Test

The prepared anode material was mixed with graphite (artificial graphite S360 series) at a ratio of 10:90. This mixture was then mixed with sodium Carboxymethyl Cellulose (CMC), a binder Styrene-Butadiene Rubber (SBR), a conductive agent Super-P, and a conductive agent KS-6 at a mass ratio of 92:2:2:4 to form a slurry. The slurry was coated onto copper foil, vacuum-dried, and roll-pressed to prepare an anode plate. Lithium foil was used as the counter electrode. A button battery was assembled using 1 mol/L LiPF₆/ethylene carbonate+dimethyl carbonate+methyl ethyl carbonate (v/v=1:1:1) electrolyte and Celgard2400 separator.

The cycling performance was tested using a constant current charging and discharging experiment with a current of 30 mA, and the charging and discharging voltage was limited to 0-1.5 V. The testing was performed using a LAND battery testing system from Wuhan Jinnuo Electronics Co., Ltd. At room temperature, the button battery was cycled for one week at 0.1 C, 0.2 C, and 0.5 C, and then charged and discharged at 1 C for 47 cycles. A 50-cycle capacity retention rate of the product was calculated by dividing the capacity of the 50th week by the capacity of the first week. A ratio of the capacity at 0.1C to that at 1C was used to evaluate the rate performance of the product.

The anode material prepared in each embodiment and comparative example was used as an anode precursor. A mass ratio of the precursor, the conductive agent (Super-P), to the binder (CMC+SBR) in an electrode plate coating was 92:4:4, and lithium foil was used as the counter electrode. The button battery was assembled using a 1 mol/L LiPF₆/EC+DMC+EMC (v/v=1:1:1) electrolyte and a Celgard2400 separator. The first-cycle charging and discharging test was performed on this type of battery using the following charging and discharging regime:

Charging: constant current charge at 0.1 C to 10 mV, constant current charge at 0.02 C to 5 mV; Discharging: constant current discharge at 0.1 C to 1.5 V.

The embodiments of the present disclosure are further described below with a plurality of embodiments. The embodiments of the present disclosure are not limited to the following specific embodiments. Implementation may be appropriately modified as long as the main claims remain unchanged.

### Embodiment 1

A method for preparing an anode material included the following steps.
(1) A mixture of silicon and silicon dioxide was placed in a reaction chamber, evacuated to a vacuum degree below 1×10⁻⁴ Pa, and heated to 1100° C. to form a vapor through vaporization. In a vacuum deposition chamber, helium was used to generate a plasma stream at a radio frequency power of 30 kW. The vapor was delivered into the plasma stream to undergo a plasma reaction. The solid collected after condensation was crushed into a precursor with D₅₀=12 μm.
(2) The precursor was subjected to a carbon coating treatment using a CVD method at 700° C. for 6 h, and a carbon-coated product was subjected to a heat treatment at 1100° C. for 1 h to obtain the anode material.

The anode material of this embodiment included an active material core and a carbon layer. The active material core included Si and SiOₓ (0<x≤2). The parameters of the anode material were detailed in Table 1.

### Embodiment 2

A method for preparing an anode material included the following steps.
(1) A mixture of silicon, silicon dioxide, and magnesium oxide was placed in a reaction chamber, evacuated to a vacuum degree below 1×10⁻⁴ Pa, and heated to 1100° C. to form a vapor through vaporization. In a vacuum deposition chamber, helium was used to generate a plasma stream at a radio frequency power of 30 kW. The vapor was delivered into the plasma stream to undergo a plasma reaction. The solid collected after condensation was crushed into a precursor with D₅₀=12 μm.
(2) The precursor was subjected to a carbon coating treatment using a CVD method at 700° C. for 6 h, and a carbon-coated product was subjected to a heat treatment at 900° C. for 1 h to obtain the anode material.

The anode material of this embodiment included an active material core and a carbon layer. The active material core included Si, SiOₓ (0<x≤2), and magnesium silicate. The parameters of the anode material were detailed in Table 1.

### Embodiment 3

A method for preparing an anode material included the following steps.
(1) A mixture of silicon, silicon dioxide, and magnesium metal was placed in a reaction chamber, evacuated to a vacuum degree below 1×10⁻⁴ Pa, and heated to 1100° C. to form a vapor through vaporization. In a vacuum deposition chamber, helium was used to generate a plasma stream at a radio frequency power of 20 kW. The vapor was delivered into the plasma stream to undergo a plasma reaction. The solid collected after condensation was crushed into a precursor with D₅₀=12 μm.
(2) The precursor was subjected to a carbon coating treatment using a CVD method at 700° C. for 6 h, and a carbon-coated product was subjected to a heat treatment at 920° C. for 2 h to obtain the anode material.

The anode material of this embodiment included an active material core and a carbon layer. The active material core included Si, SiOₓ (0<x≤2), and magnesium silicate. Other parameters of the anode material were detailed in Table 1.

### Embodiment 4

A method for preparing an anode material included the following steps.
(1) A mixture of silicon, silicon dioxide, and lithium metal was placed in a reaction chamber, evacuated to a vacuum degree below 1×10⁻⁴ Pa, and heated to 1300° C. to form a vapor through vaporization. In a vacuum deposition chamber, helium was used to generate a plasma stream at a radio frequency power of 20 kW. The vapor was delivered into the plasma stream to undergo a plasma reaction. The solid collected after condensation was crushed into a precursor with D₅₀=6 μm.
(2) The precursor was subjected to a carbon coating treatment using a CVD method at 700° C. for 6 h, and a carbon-coated product was subjected to a heat treatment at 950° C. for 1 h to obtain the anode material.

The anode material of this embodiment included an active material core and a carbon layer. The active material core included Si, SiOₓ (0<x≤2), and lithium silicate. Other parameters of the anode material were detailed in Table 1.

### Embodiment 5

A method for preparing an anode material included the following steps.
(1) A mixture of silicon and silicon dioxide was placed in a reaction chamber, evacuated to a vacuum degree below 1×10⁻⁴ Pa, and heated to 1200° C. to form a vapor through vaporization. In a vacuum deposition chamber, helium was used to generate a plasma stream at a radio frequency power of 90 kW. The vapor was delivered into the plasma stream to undergo a plasma reaction. The solid collected after condensation was crushed into a precursor with D₅₀=5 μm.
(2) The precursor was subjected to a carbon coating treatment using a CVD method at 800° C. for 6 h, and a carbon-coated product was subjected to a heat treatment at 1000° C. for 8 h to obtain the anode material.

The anode material of this embodiment included an active material core and a carbon layer. The active material core included Si and SiOₓ (0<x≤2). Other parameters of the anode material were detailed in Table 1.

### Embodiment 6

A difference between this embodiment and Embodiment 1 lied in that the carbon-coated product was subjected to the heat treatment at 1100° C. for 18 h.

### Embodiment 7

A difference between this embodiment and Embodiment 1 lied in that the carbon-coated product was subjected to the heat treatment at 800° C. for 2 h.

### Embodiment 8

A difference between this embodiment and Embodiment 1 lied in that the particle size of the anode material was D₂₀-D₁₀=5.1 μm, D₉₀−D₈₀=9.5 μm.

### Embodiment 9

A difference between this embodiment and Embodiment 1 lied in that, in S(2), the temperature for the carbon coating reaction using the CVD method was 800° C., and the carbon-coated product was subjected to a heat treatment at 1000° C. for 18 h.

### Embodiment 10

A difference between this embodiment and Embodiment 1 lied in that, in S(1), the radio frequency power for exciting the plasma was 100 KW, and in S(2), the heat treatment temperature for the carbon-coated product was 1100° C., and the heat treatment time for the carbon-coated product was 0.5 h.

### Embodiment 11

A difference between this embodiment and Embodiment 1 lied in that, in S(1), the radio frequency power for exciting the plasma was 10 kW, and in S(2), the heat treatment temperature for the carbon-coated product was 800° C., and the heat treatment time for the carbon-coated product was 10 h.

### Comparative Example 1

A method for preparing an anode material included the following steps.
(1) A mixture of silicon and silicon dioxide was placed in a reaction chamber, evacuated to a vacuum degree below 1×10⁻⁴ Pa, and heated to 1200° C. to form a vapor through vaporization. The solid collected after condensation was crushed into a composite with D₅₀-5 μm.
(2) The composite was subjected to carbon coating using a CVD method at 800° C., and a carbon-coated product was subjected to a heat treatment at 1000° C. for 8 h to obtain the anode material.

The anode material of this embodiment included an active material core and a carbon layer. The active material core included Si and SiOₓ (0<x≤2). Parameters of the anode material were detailed in Table 1.

### Comparative Example 2

A method for preparing an anode material included the following steps.
(1) A mixture of silicon and silicon dioxide was placed in a reaction chamber, evacuated to a vacuum degree below 1×10⁻⁴ Pa, and heated to 1200° C. In a vacuum deposition chamber, neon was used to generate a plasma stream at a radio frequency power of 5 kW. The vapor was delivered into the plasma stream to undergo a plasma reaction. The solid collected after condensation was crushed into a composite with D₅₀=5 μm.
(2) The composite was subjected to carbon coating using a CVD method at 900° C., and a carbon-coated product was subjected to a heat treatment at 1200° C. for 20 h to obtain the anode material.

The anode material of this embodiment included an active material core and a carbon layer. The active material core included Si and SiOₓ (0<x≤2). Other parameters of the anode material were detailed in Table 1.

### Comparative Example 3

A method for preparing an anode material included the following steps.
(1) A mixture of silicon and silicon dioxide was placed in a reaction chamber, evacuated to a vacuum degree below 1×10⁻⁴ Pa, and heated to 1200° C. to form a vapor through vaporization. The solid collected after condensation was crushed into a composite with D₅₀₌₅ μm.
(2) The composite was subjected to carbon coating using a CVD method at 700° C., and a carbon-coated product was subjected to a heat treatment at 400° C. for 24 h to obtain the anode material.

The anode material of this embodiment included an active material core and a carbon layer. The active material core included Si and SiOₓ (0<x≤2). Parameters of the anode material were detailed in Table 1.

### Comparative Example 4

A difference between this embodiment and Embodiment 1 lied in that the carbon-coated product was subjected to the heat treatment at 1400° C. for 8 h.

Performance tests were performed on the anode materials prepared in the embodiments and comparative examples. The results of the above performance tests were shown in Table 1.

TABLE 1
Summary of performance test results

| | Mass | Average | | | | | | First- | | 50- | |
|---|---|---|---|---|---|---|---|---|---|---|---|
| | content of | silicon | | | | | | cycle | First-cycle | cycles | 1 C/0.1 |
| | crystalline | grain | | | D₂₀ − | D₉₀ − | | reversible | coulombic | retention | C rate |
| | silicon A | size B | | | D₁₀ | D₈₀ | | capacity | efficiency | rate | capability |
| Sample | (%) | (nm) | A/B | A + B | (μm) | (μm) | pH | mAh/g | (%) | (%) | (%) |
| Embodiment 1 | 11.44 | 3.8 | 3.01 | 15.24 | 1.1 | 2.6 | 8 | 1607.5 | 77.7 | 88.0 | 94 |
| Embodiment 2 | 28.50 | 8.1 | 3.43 | 36.3 | 2.1 | 3.5 | 8 | 1491.1 | 83.2 | 88.7 | 93 |
| Embodiment 3 | 18.52 | 6.7 | 2.76 | 25.22 | 1.8 | 3.0 | 8 | 1431.2 | 85.7 | 88.4 | 93 |
| Embodiment 4 | 37.11 | 7.2 | 5.15 | 44.31 | 3.2 | 2.0 | 7 | 1456.6 | 87.1 | 88.3 | 95 |
| Embodiment 5 | 18.55 | 4.1 | 4.52 | 22.65 | 1.2 | 2.1 | 8 | 1622.4 | 77.3 | 89.1 | 96 |
| Embodiment 6 | 62.22 | 6.1 | 10.20 | 68.32 | 1.9 | 3.1 | 9 | 1520.1 | 79.2 | 87.5 | 93 |
| Embodiment 7 | 6.11 | 2.5 | 2.44 | 8.61 | 2.0 | 2.9 | 8 | 1630.2 | 76.5 | 86.1 | 94 |
| Embodiment 8 | 11.44 | 3.8 | 3.01 | 15.24 | 5.1 | 9.5 | 8 | 1587.5 | 75.7 | 61.0 | 81 |
| Embodiment 9 | 66.72 | 7.0 | 9.53 | 73.72 | 2.1 | 3.0 | 8 | 1541.2 | 78.7 | 88.1 | 91 |
| Embodiment 10 | 2.83 | 6.9 | 0.41 | 9.73 | 1.0 | 2.4 | 8 | 1856.7 | 76.5 | 82.5 | 90.7 |
| Embodiment 11 | 62.37 | 1.1 | 56.7 | 63.47 | 1.3 | 2.9 | 8 | 1521.5 | 79.1 | 83.7 | 88.1 |
| Comparative | 0.5 | 1.8 | 0.28 | 2.28 | 5.9 | 3.7 | 8 | 1741.8 | 75.4 | 63.8 | 86.2 |
| example 1 | | | | | | | | | | | |
| Comparative | 75 | 8.55 | 9.15 | 83.2 | 2.3 | 8.1 | 8 | 1421.1 | 78.2 | 67.7 | 76.3 |
| example 2 | | | | | | | | | | | |
| Comparative | 69.6 | 1.1 | 63.27 | 70.7 | 3.1 | 5.7 | 9 | 1685.4 | 74.1 | 43.2 | 51.2 |
| example 3 | | | | | | | | | | | |
| Comparative | 55.4 | 20.6 | 2.69 | 76 | 2.1 | 5.6 | 8 | 1424.0 | 68.2 | 73.5 | 42.1 |
| example 4 | | | | | | | | | | | |

Based on the data in Table 1, it might be seen that, by controlling the relationship between the mass ratio of crystalline silicon in silicon and the average silicon grain size, significant improvements were achieved in the lithium-ion transport impedance, the stability of a solid-liquid interface, and the stability of the crystalline structure during long-term cycling. Specifically, crystalline silicon was structurally more stable than amorphous substances. During cycling, the peak intensity and peak position in the dQ/dV curve underwent little change during cycling. However, the expansion of crystalline silicon was anisotropic, resulting in non-uniform expansion stress that could cause fragmentation of the anode particles and exposure of more silicon interfaces. This, in turn, induced side reactions with the electrolyte and continuous growth and thickening of the SEI film, leading to degradation of interface stability. Amorphous silicon (including elemental and compound forms) might stabilize the overall structure of the anode particles and buffer expansion deformation, thereby reducing fragmentation of the anode particles and improving interface stability. At the same time, the amorphous material was isotropic, such that lithium intercalation did not exhibit directional preference, resulting in lower lithium-ion transport impedance. In summary, by regulating both the mass ratio of crystalline silicon and the average silicon grain size, the anode product might simultaneously achieve low lithium-ion transport impedance, high stability of the solid-liquid interface, and strong stability of the crystalline structure during long-term cycling, thereby significantly enhancing product performance.

In Embodiment 7, the mass content of crystalline silicon decreased compared to Embodiment 1. This was because the temperature during the heat treatment of the carbon-coated product was relatively low and the time was too short. Therefore, a portion of the silicon did not form crystalline silicon, which slightly decreased the cycling performance of the anode material.

The anode material prepared in Embodiment 8 had a particle size deviating from the ranges D₂₀-D₁₀≤4 μm and D₉₀-D₈₀≤8 μm. The particle size distribution uniformity of the anode material was poor, and abnormal particles existed at both ends of the anode material. Therefore, the cycling performance of the anode material decreased slightly.

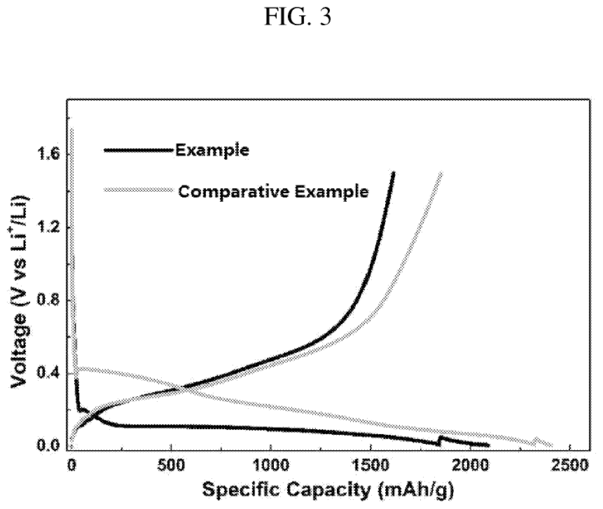

In Comparative Example 1, during the preparation of the composite, the vapor was not delivered into the plasma stream to undergo the plasma reaction. After losing the inducing effect of the crystal seeds, the mass content of crystalline silicon decreased significantly. As shown in FIG. 3, compared with Embodiment 1, although the first-cycle reversible capacity of the anode material increased, its cycling performance decreased significantly, and the rate performance also decreased.

In Comparative example 2, the heat treatment temperature was too high, and the treatment time was too long, causing the mass content of crystalline silicon to increase significantly and exceed the expected range. The size of the silicon particles also increased, leading to an imbalance in the ratio of amorphous silicon to crystalline silicon. This imbalance easily caused excessive local expansion stress in the anode material, resulting in a decrease in both rate performance and cycling performance of the anode material.

In Comparative example 3, the crystal seeds were not produced using the plasma, and the carbonization temperature was too low. After long-term carbonization, the silicon grains could hardly grow, causing the mass content of crystalline silicon to increase significantly and exceed the expected range. This also caused A/B to exceed the required range, leading to degradation in product performance.

In Comparative example 4, the carbonization temperature for the semi-finished product containing the seed crystals was too high, leading to rapid growth of the silicon crystals. Although the mass content of crystalline silicon did not exceed the expected range, it still caused uncontrolled expansion stress in the product, resulting in performance degradation.

Although the present disclosure is disclosed above with preferred embodiments, it is not intended to limit the claims. Those skilled in the art can make several possible changes and modifications without departing from the concept of the present disclosure. Therefore, the scope of protection of the present disclosure shall be based on the scope defined by the claims of the present disclosure.

1. An anode material, wherein:
the anode material contains silicon, and at least a portion of the silicon is present in the form of crystalline silicon;
based on a mass content of silicon in the anode material being 100%, a mass content of the crystalline silicon is A %, and an average silicon grain size of the crystalline silicon is B nm; and
the anode material satisfies the following features: 0.3≤A/B≤60 and 6≤A+B≤75.

2. The anode material according to claim 1, wherein A is in the range of 5-65.

3. The anode material according to claim 1, wherein B≤7.

4. The anode material according to claim 1, satisfying at least one of the following features (1) to (3):
(1) the anode material further comprises oxygen, and an atomic ratio of oxygen to silicon in the anode material is x, 0<x<2.2;
(2) the anode material further comprises oxygen, and components containing oxygen and silicon comprise at least one of a silicon oxide or a silicate; and
(3) the anode material further comprises carbon, and components containing carbon in the anode material comprise at least one of amorphous carbon, graphite, graphene, a carbon nanotube, or a carbon fiber.

5. The anode material according to claim 1, further comprising a metal element selected from at least one of Li, Mg, Cu, Ni, Fe, Cr, or Zn.

6. The anode material according to claim 5, wherein the metal element contains Mg, and a mass content of Mg in the anode material is 3%-25%.

7. The anode material according to claim 5, wherein the metal element contains Li, and a mass content of Li in the anode material is 3%-15%.

8. The anode material according to claim 1, satisfying at least one of the following features (1) to (3):
(1) a mass content of oxygen in the anode material is 10%-55%;
(2) a mass content of carbon in the anode material is 1%-40%; or
(3) a mass content of silicon in the anode material is 25%-88%.

9. The anode material according to claim 1, further comprising a carbon layer, and at least part of a surface of the anode material is provided with the carbon layer.

10. The anode material according to claim 1, satisfying at least one of the following features (1) to (2):
(1) a specific surface area of the anode material is 0.1 m²/g-25 m²/g; or
(2) a true density of the anode material is 2.0 g/cm³-3.4 g/cm³.

11. The anode material according to claim 1, wherein a particle size of the anode material satisfies: D₂₀-D₁₀≤4 μm and D₉₀-D₈₀≤8 μm.

12. The anode material according to claim 1, wherein:
10 g of the anode material is taken;
10 g of water is added, stirring is performed for 30 min; and
a pH value is measured using a pH meter calibrated with a standard solution, so as to obtain a pH of the anode material being between 6 and 10.

13. The anode material according to claim 6, wherein the metal element comprises Mg and B≤15.

14. The anode material according to claim 7, wherein the metal element comprises Li and B≤10.

15. The anode material according to claim 8, wherein a mass content of silicon in the anode material is 40%-60%.

16. The anode material according to claim 10, wherein a specific surface area of the anode material is 1 m²/g-10 m²/g.

17. The anode material according to claim 12, wherein a pH of the anode material is between 7 and 10.

18. A battery, comprising the anode material according to claim 1.
